(19) United States
(12) Patent Application Publication
(10) Pub. No.: US 2026/0327891 A1
(43) Pub. Date: Oct. 22, 2026

(54) CLOTHES TREATING APPARATUS

(71) Applicant: SAMSUNG ELECTRONICS CO., LTD., Suwon-si (KR)

(72) Inventors: Sangho PARK, Suwon-si (KR); Incheol JANG, Suwon-si (KR)

(73) Assignee: SAMSUNG ELECTRONICS CO., LTD., Suwon-si (KR)

(21) Appl. No.: 19/465,607

(22) Filed: Jan. 30, 2026

Related U.S. Application Data
(63) Continuation of application No. PCT/KR2024/008708, filed on Jun. 24, 2024.

(30) Foreign Application Priority Data
Jul. 31, 2023 (KR) 10-2023-0099882

(51) Int. Cl. D06F 39/14

(52) U.S. Cl. CPC D06F 39/14

(57) ABSTRACT

A clothes treating apparatus includes a housing including a housing opening through which laundry is introduced, a tub to be provided inside the housing, a drum, which is rotatable, to be provided inside the tub, a diaphragm to connect the housing and the tub, and a door configured to open or close the housing opening, wherein the door includes a door glass, a door frame configured to support the door glass, and a door protrusion configured to protrude from the door frame toward a front surface of the housing, and the door protrusion includes a first protrusion portion to be positioned below the housing opening when the door is closed, and a second protrusion portion to extend downwardly from the first protrusion portion and be closer to the front surface of the housing than the first protrusion portion.

### CROSS-REFERENCE TO RELATED APPLICATION

This application is a continuation application, under 35 U.S.C. §111(a), of international application No. PCT/KR2024/008708, filed Jun. 24, 2024, which claims priority under 35 U. S. C. §119 to Korean Patent Application No. 10-2023-0099882, filed Jul. 31, 2023, the disclosures of which are incorporated herein by reference in their entireties.

### TECHNICAL FIELD

The disclosure relates to a clothes treating apparatus.

### BACKGROUND ART

A washing machine, which is an example of a clothes treating apparatus, is an apparatus that performs washing through mutual friction by stirring together laundry, water, and detergent received in a tub using a driving force of a drive motor.

Regardless of the type of washing machine, the cycles performed by the washing machine may include a washing cycle in which detergent and water are supplied to a tub in which laundry is received and the drum is rotated to wash the laundry, a rinsing cycle in which water is supplied to the tub and the drum is rotated to rinse the laundry, and a dewatering cycle in which water is discharged from the tub and the drum is rotated to remove water from the laundry.

In the process of loading clothes through an opening of a cabinet to operate the washing machine, it may occur that the clothes are not fully loaded and the door is closed. In this case, when the operations proceeds in such a state, the clothes may be damaged or a diaphragm may be deformed. This may result in a risk of water leakage to the outside of the washing machine.

### DISCLOSURE

### Technical Problem

An embodiment of the disclosure provides a clothes treating apparatus that prevents a door from being closed while laundry is caught.

An embodiment of the disclosure provides a clothes treating apparatus that prevents the door from being closed when laundry is caught, thereby preventing operation of the clothes treating apparatus to avoid damage to the laundry and water leakage.

The technical object intended to be achieved by the present document is not limited to the above-mentioned technical objects, and other technical objects not mentioned will be clearly understood by one of ordinary skill in the technical art to which the disclosure belongs from the following description.

### Technical Solution

To solve the above problems, a clothes treating apparatus according to the concept of the present disclosure includes a housing including a housing opening through which laundry is introduced, a tub to be provided inside the housing, a drum, which is rotatable, to be provided inside the tub, a diaphragm to connect the housing and the tub, and a door configured to open or close the housing opening, wherein the door includes a door glass, a door frame configured to support the door glass, and a door protrusion configured to protrude from the door frame toward a front surface of the housing, and the door protrusion includes a first protrusion portion to be positioned below the housing opening when the door is closed and a second protrusion portion to extend downwardly from the first protrusion portion and be closer to the front surface of the housing than the first protrusion portion.

A clothes treating apparatus according to the concept of the present disclosure includes a housing including a housing opening through which laundry is loaded, a tub provided inside the housing, a drum, which is rotatable, to be provided inside the tub, a diaphragm to connect the housing and the tub, and a door to be provided to open or close the housing opening, wherein the door includes a door glass, a door frame provided to support the door glass, and a plurality of protrusions protruding from the door frame toward a front surface of the housing, and the door frame includes a first rim portion provided to correspond to the diaphragm and a second rim portion to be connected to the first rim portion and be on an outer side of the door frame relative to the first rim portion, and a plurality of protrusions are arranged to protrude from the second rim portion along a circumference of the housing opening, and the housing includes a plurality of recesses corresponding to the plurality of protrusions and concavely formed to receive the plurality of protrusions.

### Advantageous Effects

According to the present disclosure, the door protrusion may narrow the gap between the door and the diaphragm or the door and the housing, thereby preventing the locking of the door in the event of laundry being caught.

According to the present disclosure, the locking of the door may be prevented by using the structure of the protrusion and the recess when laundry is caught between the main body and the door, thereby preventing the clothes treating apparatus from operating to avoid laundry damage and water leakage.

### DESCRIPTION OF DRAWINGS

FIG. 1 is a cross-sectional view of a clothes treating apparatus according to an embodiment of the present disclosure.

FIG. 2 is a perspective view of the clothes treating apparatus according to an embodiment of the present disclosure.

FIG. 3 is a plan view of the door of FIG. 2 according to an embodiment of the present disclosure.

FIG. 4 is a side view of the door of FIG. 2 according to an embodiment of the present disclosure.

FIG. 5 is a cutaway perspective view of the door of FIG. 2 according to an embodiment of the present disclosure.

FIG. 6 is an enlarged cross-sectional view of the clothes treating apparatus according to an embodiment of the present disclosure.

FIG. 7 is a view illustrating a situation where laundry is draped over the clothes treating apparatus according to an embodiment of the present disclosure.

FIG. 8 is an enlarged cross-sectional view of a situation where laundry is caught when attempting to close the door of the clothes treating apparatus according to an embodiment of the present disclosure.

FIG. 9 is a plan view of a door of a clothes treating apparatus according to an embodiment of the present disclosure.

FIG. 10 is an enlarged cross-sectional view of the clothes treating apparatus according to an embodiment of the present disclosure.

FIG. 11 is an enlarged cross-sectional view of the clothes treating apparatus according to an embodiment of the present disclosure.

FIG. 12 is a perspective view illustrating a clothes treating apparatus according to an embodiment of the present disclosure.

FIG. 13 is an enlarged cross-sectional view illustrating a portion of a cross-section of the clothes treating apparatus of FIG. 12 according to an embodiment of the present disclosure.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A washing machine according to various embodiments may perform washing, rinsing, spin-drying, and drying processes. The washing machine is an example of a clothes treating apparatus, and the clothes treating apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry inlet for inserting or removing laundry is provided to face upward, or a front-loading washing machine in which a laundry inlet is provided to face forward. The washing machine according to various embodiments may include a washing machine of a loading type other than the top-loading washing machine and the front-loading washing machine.

For the top-loading washing machine, laundry may be washed using water current generated by a rotating body such as a pulsator. For the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum and a condensing device for removing moisture from air discharged from the drum. For example, the dryer combined washing machine may include a heat pump device. The washing machine according to various embodiments may include a washing machine using a washing method other than the above-described washing method.

The washing machine according to various embodiments may include a housing accommodating various components therein. The housing may be provided in the form of a box including a laundry inlet on one side thereof.

The washing machine may include a door for opening and closing the laundry inlet. The door may be rotatably mounted to the housing by a hinge. At least a portion of the door may be transparent or translucent to allow the inside of the housing to be visible.

The washing machine may include a tub disposed within the housing to store water. The tub may be formed in a substantially cylindrical shape with a tub opening formed on one side thereof. The tub may be disposed inside the housing in such a way that the tub opening corresponds to the laundry inlet.

The tub may be connected to the housing by a damper. The damper may absorb vibration generated when the drum rotates, and the damper may reduce vibration transmitted to the housing.

The washing machine may include a drum provided to accommodate laundry.

The drum may be disposed inside the tub such that a drum opening provided on one side of the drum corresponds to the laundry inlet and the tub opening. Laundry may pass sequentially through the laundry inlet, the tub opening, and the drum opening and then be received in the drum or removed from the drum.

The drum may perform each operation according to washing, rinsing, and/or spin-drying while rotating in the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply device configured to supply water to the tub. The water supply device may include a water supply pipe and a water supply valve disposed in the water supply pipe. The water supply pipe may be connected to an external water supply source. The water supply pipe may extend from an external water supply source to a detergent supply device and/or the tub. Water may be supplied to the tub through the detergent supply device. Alternatively, water may be supplied to the tub without passing through the detergent supply device.

The water supply valve may open or close the water supply pipe in response to an electrical signal from a controller. The water supply valve may allow or block the supply of water to the tub from an external water supply source. The water supply valve may include a solenoid valve configured to open or close in response to an electrical signal.

The washing machine may include the detergent supply device configured to supply detergent to the tub. The detergent supply device may include a manual detergent supply device that requires a user to enter detergent to be used for each washing, and an automatic detergent supply device that stores a large amount of detergent and automatically adds a predetermined amount of detergent during washing. The detergent supply device may include a detergent container for storing detergent. The detergent supply device may be configured to supply detergent into the tub during a water supply process. Water supplied through the water supply pipe may be mixed with detergent via the detergent supply device. Water mixed with detergent may be supplied into the tub. Detergent is used as a term including detergent for pre-washing, detergent for main washing, fabric softener, bleach, etc., and the detergent container may be partitioned into a storage region for the pre-washing detergent, a storage region for the main washing detergent, a storage region for the fabric softener, and a storage region for the bleach.

The washing machine may include a drainage device configured to discharge water contained in the tub to the outside. The drainage device may include a drain pipe extending from a bottom of the tub to the outside of the housing, a drain valve disposed on the drain pipe to open or close the drain pipe, and a pump disposed on the drain pipe. The pump may pump water from the drain pipe to the outside of the housing.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output via a screen, an indicator, or a voice. The at least one output interface may include a liquid crystal display (LCD) panel, a light emitting diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between the external devices, and support the performance of the communication through the established communication channel. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

According to an embodiment, the communication module may communicate with an external device such as a server, a user device and other home appliances through an access point (AP). The AP may connect a LAN, to which a washing machine or a user device is connected, to a WAN to which a server is connected. The washing machine or the user device may be connected to the server via the WAN. The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, a clothes treating apparatus according to various embodiments will be described in detail with reference to the accompanying drawings.

A washing machine will be described as an example of a clothes treating apparatus 1, but the concept of the present disclosure is not limited to being applied to a washing machine, and may be applicable to any clothes treating apparatus 1, such as a dryer, into which laundry is loaded for operation.

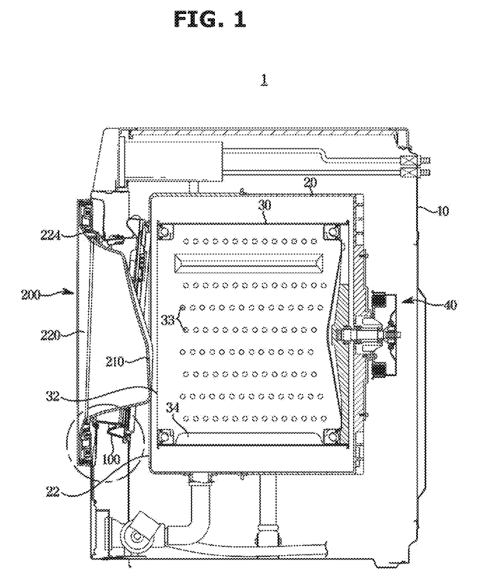

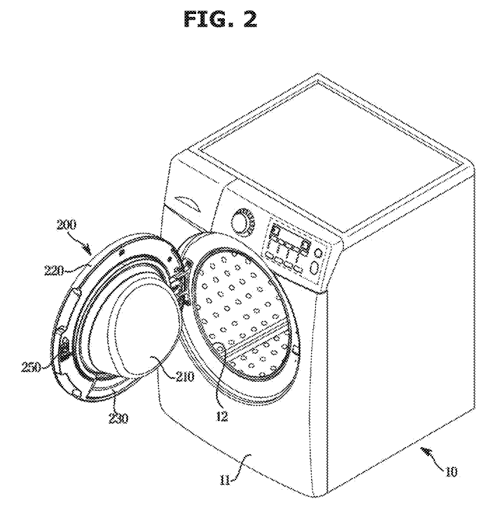

FIG. 1 is a cross-sectional view of the washing machine 1 according to an embodiment of the present disclosure, and FIG. 2 is a perspective view of the washing machine 1 according to an embodiment of the present disclosure.

As shown in FIGS. 1 and 2, the washing machine 1 may be configured to include a housing 10, a tub 20 installed inside the housing 10 to store water, a drum 30 rotatably disposed inside the tub 20, and a motor to drive the drum 30.

The housing 10 may include a housing opening 12 formed to be accessible to an interior of the drum 30. The washing machine 1 may include a door 200 for opening and closing the housing opening 12 provided in the housing 10. The door 200 may be rotatably mounted to the housing 10 by a hinge. A door glass 210 of the door 200 may be transparent or translucent to allow an interior of the housing 10 to be visible.

The washing machine 1 may include the tub 20 provided inside the housing 10 to store water. The tub 20 may be disposed inside the housing 10. The tub 20 may include a tub opening 22 provided to correspond to the housing opening 12. The tub 20 may be supported inside the housing 10. The tub 20 may have a substantially cylindrical shape with one side open.

The tub 20 may be elastically supported from the housing 10 by a damper. The damper may connect the housing 10 and the tub 20. The damper may be configured to absorb vibration energy to attenuate vibrations when vibrations generated by rotation of the drum 30 are transmitted to the tub 20 and the housing 10.

The washing machine 1 may include the drum 30 configured to receive laundry. The drum 30 may be rotatably arranged inside the tub 20. The drum 30 may perform washing, rinsing, and/or dewatering (or spin-drying) while rotating within the tub 20. The drum 30 may have a substantially cylindrical shape with one side open.

A plurality of through-holes 33 for the circulation of washing water may be formed on a circumference of the drum 30, and lifters 34 may be installed on an inner circumferential surface of the drum 30 to allow the laundry to be lifted and dropped as the drum 30 rotates.

The drum 30 may include a drum opening 32 provided to correspond to the housing opening 12 and the tub opening 22. Laundry may be inserted into or removed from the drum 30 through the housing opening 12, the tub opening 22, and the drum opening 32.

The washing machine 1 may include a washing machine drive device 40 configured to rotate the drum 30. The washing machine drive device 40 may include a motor. The motor may include a stator fixed to the tub 20 and a rotor rotatably disposed about the stator. The rotor may electromagnetically interact with the stator to rotate and may transmit a rotational force to a drive shaft.

The housing opening 12 may be formed in a front panel 11 of the housing 10. The housing opening 12 may be opened or closed by the door 200 installed on the front panel 11 of the housing 10. The door 200 may include the door glass 210 configured to allow viewing of the interior of the drum 30 and a door frame 220 configured to support the door glass 210.

A diaphragm 100 may be installed between the tub 20 and the door 200. The diaphragm 100 may connect the housing opening 12 and the tub opening 22, may form a passageway from the housing opening 12 to the tub opening 22, and may reduce vibrations transmitted to the housing upon rotation of the drum 30. In addition, the diaphragm 100 may be disposed between the door 200 and the front panel 11 to prevent water from leaking out of the housing 10.

The diaphragm 100 may be configured as an injection-molded product made of a thermoplastic elastomer. Since the thermoplastic elastomer has elasticity like rubber at room temperature, the diaphragm 100 formed of the thermoplastic elastomer may effectively dampen vibrations transmitted from the tub 20 to the front panel 11 of the housing 10.

The diaphragm 100 may be coupled to the housing 10 by a fixing member 510. Specifically, the fixing member 510 may secure a housing lip portion 14, which forms the circumference of the housing opening 12, and a housing coupling portion 110 of the diaphragm 100.

At a front end of the diaphragm 100, a diaphragm lip portion 130 may be formed. The diaphragm lip portion 130 may protrude in a direction toward the center of the housing opening 12 from the fixing member 510 side and be formed in an annular shape along the circumference of the housing opening 12.

When the door 200 of the washing machine 1 is closed, the diaphragm lip portion 130 may contact and seal the door glass 210 to prevent water from leaking between the door 200 and the front panel 11 of the housing 10. In some cases, the diaphragm lip portion 13 may also prevent water leakage by contacting and sealing the door frame 220.

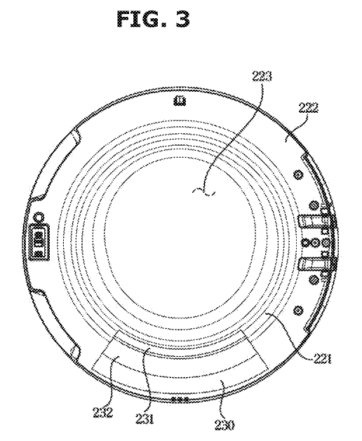

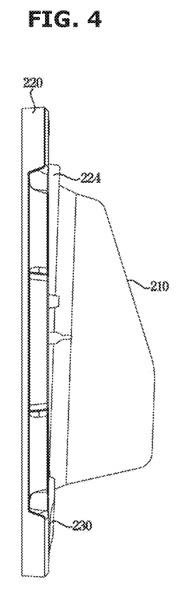

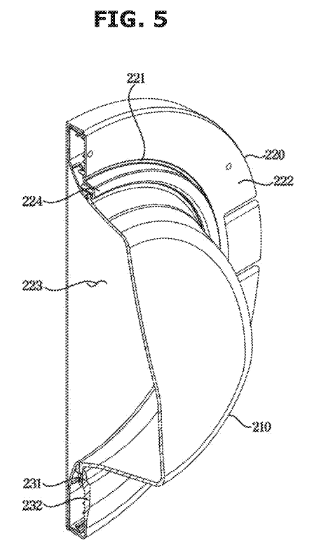

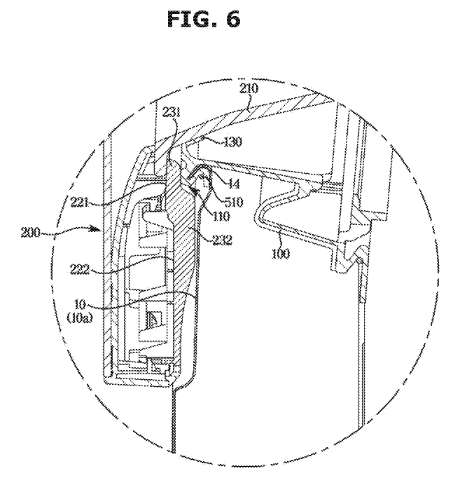

FIG. 3 is a plan view of the door 200 of FIGS. 2, 4, is a side view of the door 200 of FIGS. 2, 5, is a cutaway perspective view of the door 200 of FIGS. 2 and 6, is an enlarged cross-sectional view of the washing machine 1 according to an embodiment of the present disclosure.

The door 200 may include the door glass 210 provided to allow viewing of the interior of the drum 30 and the door frame 220 provided to support the door glass 210. A portion of the door glass 210 may contact the diaphragm 100 to prevent water inside the drum 30 from leaking to the outside of the housing 10.

Assuming no the door glass 210 of the door 200, the door frame 220 may include a frame opening 223 at its center that is provided to correspond to the housing opening 12 when the door is closed.

The door 200 may be configured to open or close the inside of the washing machine 1. The door 200 may be locked by a door locking device 250. The door locking device 250 may be locked by a combination of a latch portion formed on one of the door 200 and the housing 10, and a hook formed on the other of the door 200 and the housing 10 to engage the latch portion. The door locking device 250 may be formed in the form of a locking device using a hook, a loop, a bar, or a solenoid, but is not limited thereto.

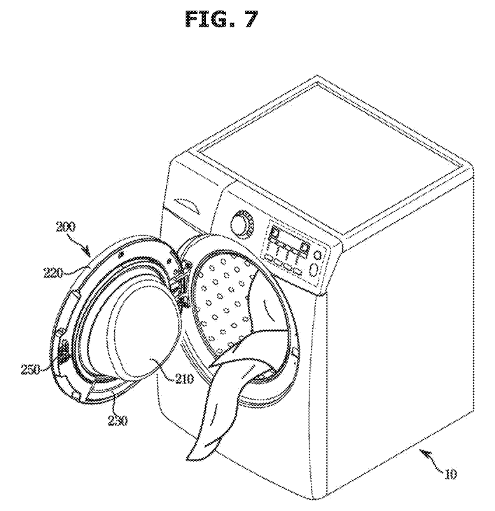

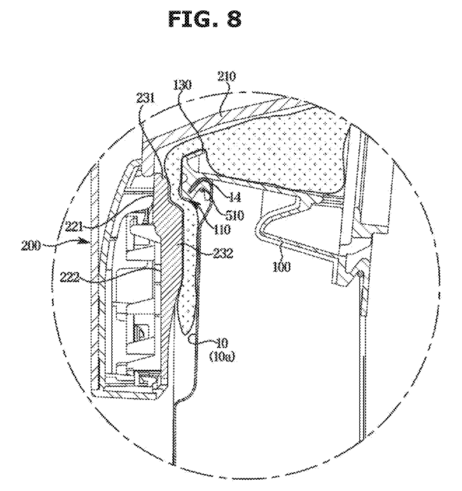

The washing machine 1 may proceed with its operation only when the door 200 is in a closed state. When laundry is loaded into the washing machine 1, the laundry may not be fully inserted into the drum 30, causing the laundry to be caught in the door 200 (see FIGS. 7 and 8).

When a user applies force to close the door 200 even though the laundry is caught, the washing machine 1 may operate with the laundry caught in the door 200. As a result, the laundry caught in the door 200 may be rotated by the drum 30, permanently damaging the diaphragm 100 and potentially causing leaks or damaging the laundry.

A gap between the door 200 and the housing 10 or between the door 200 and the diaphragm 100 may be reduced to prevent the door 200 from being closed with laundry caught therein.

To prevent the door 200 from being closed with laundry caught therein, the door 200 may include a door protrusion 230 protruding from the door frame 220 toward a front surface 10a of the housing.

However, the door protrusion 230 may not be necessarily required to protrude from the door frame 220, and it is sufficient that the door protrusion 230 is able to reduce the gap between the door 200 and the housing 10 or between the door 200 and the diaphragm 100 so that the door 200 is prevented from closing. In other words, the door protrusion 230 may be formed to protrude from the housing 10 rather than the door frame 220.

Referring to FIG. 6, the door frame 220 may include a first rim portion 221 on an inner side of the door frame 220 and a second rim portion 222 extending from the first rim portion 221 to an outer side of the door frame 220.

Specifically, the first rim portion 221 may correspond to a front surface of the housing coupling portion 110 of the diaphragm 100, and the second rim portion 222 may correspond to the front surface 10a of the housing.

The door protrusion 230 may include a first protrusion portion 231 protruding from the first rim portion 221 and a second protrusion portion 232 protruding from the second rim portion 222.

The first protrusion portion 231 may protrude toward the diaphragm 100, particularly toward the front surface of the housing coupling portion 110 of the diaphragm 100, and the second protrusion portion 232 may protrude toward the front surface 10a of the housing.

To effectively achieve the effect of preventing the door 200 from closing when laundry is caught therein, the first protrusion portion 231 may be preferably in contact with the diaphragm 100 and the second protrusion portion 232 may be preferably in contact with the front surface 10a of the housing.

Even though the second protrusion portion 232 and the front surface 10a of the housing do not contact, the second protrusion portion 232 may include a protruding surface 2321 extending in a vertical direction to be parallel to the front surface 10a of the housing.

The first protrusion portion 231 and the second protrusion portion 232 may protrude a predetermined distance spaced from the diaphragm 100 and the front surface 10a of the housing, respectively.

The first protrusion portion 231 may correspond to the diaphragm 100 and the second protrusion portion 232 may correspond to the front surface 10a of the housing, so that the second protrusion portion 232 may be disposed closer to the front surface 10a of the housing than the first protrusion portion 231 to prevent laundry from being caught.

The closer the narrowest portion of the gap between the second protrusion portion 232 and the front surface 10a of the housing, or a portion where the second protrusion portion 232 and the front surface 10a of the housing are in contact, is to the first protrusion portion 231, the more effectively the closing of the door 200 may be prevented.

The wider the area where the laundry is caught in the door 200, the more stably the closing of the door 200 may be prevented. Accordingly, the first protrusion portion 231 and the second protrusion portion 232 of the door protrusion 230 may include surfaces parallel to the corresponding diaphragm 100 and front surface 10a of the housing, respectively.

For example, the second protrusion portion 232 may include the protruding surface 2321 extending in the vertical direction parallel to the front surface 10a of the housing. In some cases, a portion of the protruding surface 2321 may contact the front surface 10a of the housing.

The thickness and length of the portion of the laundry caught in the door 200 may vary. Accordingly, the closer the narrowest portion of the gap between the second protrusion portion 232 and the housing 10 is to the first protrusion portion 231, the more advantageous it may be for preventing the locking of the door 200.

To this end, the gap between the second protrusion portion 232 and the housing 10 may decrease from a lower portion of the second protrusion portion 232 to the protruding surface 2321. However, it does not necessarily have to decrease incrementally, it is sufficient as long as it tends to decrease.

Referring to FIG. 5, the door 200 may include a rim protrusion 224 formed to protrude further upwardly of the frame opening 223 along the first rim portion 221.

The rim protrusion 224 may reduce the gap between the door 200 and the housing 10 or between the door 200 and the diaphragm 100, thereby preventing laundry from becoming trapped between the door 200 and the diaphragm 100 or between the door 200 and the housing 10 at an upper portion of the door 200 when the washing machine 1 is in operation.

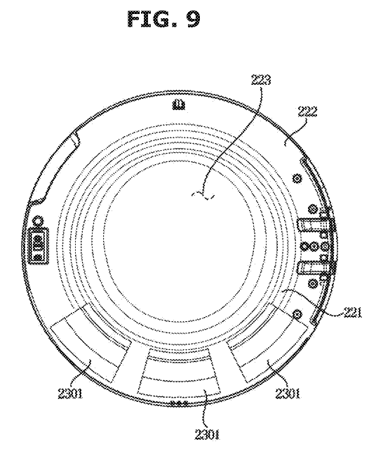

FIG. 7 is a view illustrating a situation in which laundry is draped over the washing machine 1 according to an embodiment of the present disclosure, FIG. 8 is an enlarged cross-sectional view of a situation in which laundry is caught when attempting to close the door 200 of the washing machine 1 according to an embodiment of the present disclosure, and FIG. 9 is a plan view of the door 200 of the washing machine 1 according to an embodiment of the present disclosure. The door protrusion 230 of FIG. 9 may include a plurality of protrusions 2301 disposed at predetermined intervals along a circumference of the frame opening 223.

The predetermined intervals between the plurality of protrusions 2301 may be formed narrowly to prevent the door 200 from closing when laundry is placed across the diaphragm 100. Specifically, the predetermined intervals between the plurality of protrusions 2301 may be formed to be less than a length of each of the plurality of protrusions 2301 in a circumferential direction of the frame opening 223.

As laundry is most likely to be caught in a middle portion of the door 20, the centermost protrusion of the plurality of protrusions 2301 may be formed to be the largest.

The door protrusion 230 may include a portion at a side end portion of the door protrusion 230 that decreases in cross-sectional area along the circumferential direction of the housing opening 12 from a center of the door protrusion 230.

In other words, the door protrusion 230 may include a portion that connects smoothly without forming a step between the door protrusion 230 and a rear surface of the door frame 220.

In the case where a corner is formed on the door protrusion 230, the laundry may be damaged by being caught by the corner when a user applies force to the door 200 with laundry caught therein, but such a condition may be solved when a fillet portion with a decreasing cross-sectional area is formed on the corner.

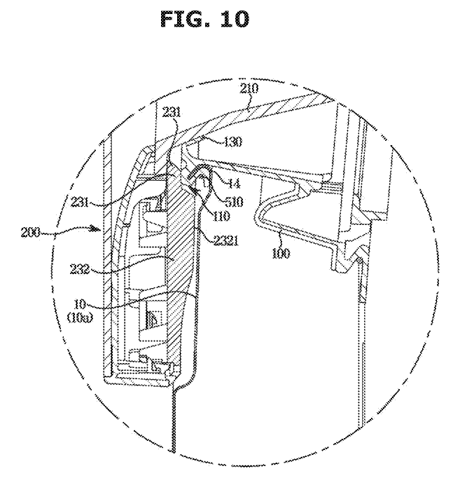

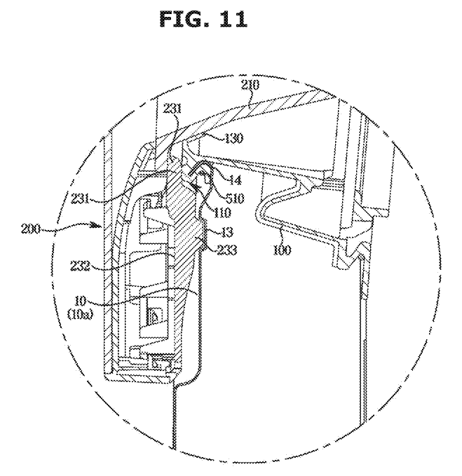

FIGS. 10 and 11 are enlarged cross-sectional views of the washing machine 1 according to an embodiment of the present disclosure.

Referring to FIG. 10, a rear surface of the first rim portion 221 and a rear surface of the second rim portion 222 may be located in one plane. In this case, the door frame 220 may be formed to facilitate easy fabrication, which may be advantageous in the manufacturing process.

The thickness of the laundry that is caught in the door 200 may vary. In a case where the laundry is thin, the door 200 may be closed when a user applies force to the door 200, even with the first protrusion portion 231 and the second protrusion portion 232.

In this case, the washing machine 1 may operate and damage the diaphragm 100 to cause leakage or damage to the laundry.

Referring to FIG. 11, to address such a situation, the door protrusion 230 may include a third protrusion portion 233 protruding further toward the front surface 10a of the housing from the second protrusion portion 232. In addition, the door protrusion 230 may include a receiving portion 13 recessedly formed to correspond to the third protrusion portion 233.

When the door protrusion 230 and the receiving portion 13 are formed with corners, there is a risk of damage to the laundry due to pinching, or the like. Thus, a fillet shape may be formed at corner portions of the third protrusion portion 233 and the receiving portion 13.

When a portion of the third protrusion portion 233 contacts a portion of the receiving portion 13, the locking of the door 200 may be more effectively prevented when laundry is caught.

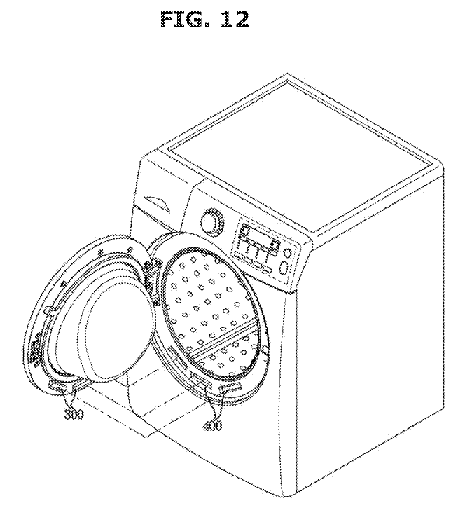

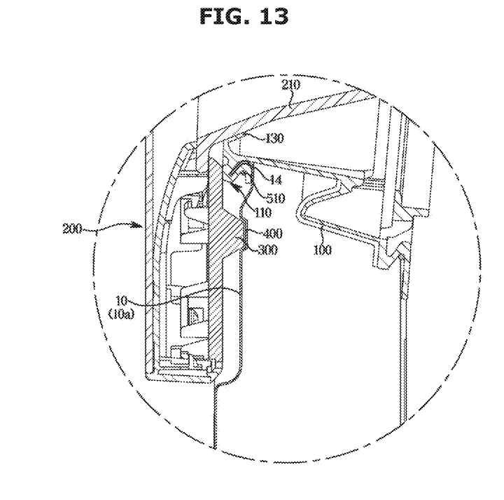

FIG. 12 is a perspective view illustrating the washing machine 1 according to an embodiment of the present disclosure, and FIG. 13 is an enlarged cross-sectional view illustrating a portion of a cross-section of the washing machine 1 of FIG. 12.

Referring to FIGS. 12 and 13, the door 200 may include a plurality of protrusions 300 provided to protrude from the door frame 220 toward the front surface 10a of the housing, and the housing 10 may include a plurality of recesses 400 for receiving the plurality of protrusions 300. However, it is not necessary that the door 200 includes the protrusions and the housing 10 includes the recesses; the door 200 may include recesses and the housing 10 may include protrusions.

The plurality of protrusions 300 and the plurality of recesses 400 may be formed along the circumference of the frame opening 223 and the housing opening 12, respectively. When a portion of the plurality of protrusions 300 and a portion of the plurality of recesses 400 are in contact, the door 200 may be more effectively prevented from closing when laundry is caught in the door 200.

Even when thin laundry is caught in the door 200, which may be able to close the door 200 in the absence of the protrusions and recesses, the engaging feature of the protrusions and recesses may prevent the door 200 from closing.

The clothes treating apparatus 1 according to an embodiment of the present disclosure may include the housing 10 including the housing opening 12 through which laundry is inserted, the tub 20 provided inside the housing 10, the drum 30 rotatably provided inside the tub 20, the diaphragm 100 connecting the housing 10 and the tub 20, and the door 200 provided to open or close the housing opening 12, wherein the door 200 may include the door glass 210 and the door frame 220 configured to support the door glass 210, and the door protrusion 230 configured to protrude from the door frame 220 toward the front surface 10a of the housing, and the door protrusion 230 may include the first protrusion portion 231 positioned below the housing opening 12 when the door 200 is closed and the second protrusion portion 232 extending downwardly from the first protrusion portion 231 and disposed closer to the front surface 10a of the housing than the first protrusion portion 231. According to the present disclosure, the door protrusion 230 may narrow the gap between the door 200 and the diaphragm 100 or between the door 200 and the housing 10, thereby preventing the door 200 from locking in the event that laundry is caught.

The door frame 220 may include the frame opening 223 corresponding to the housing opening 12, the first rim portion 221 disposed around the frame opening 223 to correspond to the diaphragm 100, and the second rim portion 222 connected to the first rim portion 221 and disposed on an outer side of the door frame 220 relative to the first rim portion 221. The first protrusion portion 231 may protrude from the first rim portion 221 toward the diaphragm 100, and the second protrusion portion 232 may protrude from the second rim portion 222 toward the front surface 10a of the housing.

The second protrusion portion 232 may include the protruding surface 2321 extending in a vertical direction to be parallel to the front surface 10a of the housing.

The protruding surface 2321 may be configured to contact the front surface 10a of the housing.

A gap between the second protrusion portion 232 and the housing 10 may decrease from a lower end of the second protrusion portion 232 to the protruding surface 2321.

The door protrusion 230 may include a portion in which a cross-sectional area of the door protrusion 230 decreases along a circumferential direction of the housing opening 12 from a center of the door protrusion 230.

The first protrusion portion 231 may be configured to contact the diaphragm 100.

The door frame 220 may include the rim protrusion 224 extending along an upper rim of the frame opening 223 and protruding from the first rim 221 toward the diaphragm 100 to contact the diaphragm 100.

The door frame 220 may include the rim protrusion 224 protruding from the first rim toward the diaphragm 100 above the first protrusion portion 231 to contact the diaphragm 100.

A distance between the second rim portion 222 and the front surface 10a of the housing may be shorter than a distance between the first rim portion 221 and the front surface 10a of the housing.

The door protrusion 230 may further include the third protrusion portion 233 protruding from the second protrusion portion 232 toward the housing 10, and the housing 10 may include the receiving portion 13 concavely formed to receive the third protrusion portion 233.

The third protrusion portion 233 may include a contact surface 2331 extending in a vertical direction to be parallel to a surface of the receiving portion 13.

A portion of the third protrusion portion 233 may be configured to contact the receiving portion 13.

The door protrusion 230 may include the plurality of protrusions 2301 disposed at predetermined intervals along a circumference of the frame opening 223.

The predetermined intervals between the plurality of protrusions 2301 may be formed smaller than a length of each of the plurality of protrusions 2301 in a circumferential direction of the frame opening 223.

The clothes treating apparatus 1 according to the concept of the present disclosure may include the housing 10 including the housing opening 12 through which laundry is loaded, the tub 20 provided inside the housing 10, the drum 30 rotatably provided inside the tub 20, the diaphragm 100 connecting the housing 10 and the tub 20, and the door 200 provided to open or close the housing opening 12, wherein the door 200 includes the door glass 210, the door frame 220 configured to support the door glass 210, and the plurality of protrusions 300 protruding from the door frame 220 toward the front surface 10a of the housing, and the door frame 220 includes the first rim portion 221 provided to correspond to the diaphragm 100 and the second rim portion 222 connected to the first rim portion 221 and disposed on an outer side of the door frame 220 relative to the first rim portion 221., wherein the plurality of protrusions 300 are arranged to protrude from the second rim portion 222 along a circumference of the housing opening 12, and the housing 10 includes the plurality of recesses 400 corresponding to the plurality of protrusions 300 and concavely formed to receive the plurality of protrusions 300. According to the present disclosure, by utilizing the structure of the protrusions and recesses to prevent locking of the door 200 when thin laundry is caught, the clothes treating apparatus 1 may be prevented from operating, thereby preventing damage to the laundry and water leakage.

A distance between the plurality of protrusions 300 and the plurality of recesses 400 may be shorter than a distance between the first rim portion 221 and the diaphragm 100.

Each of the plurality of protrusions 300 may include a portion in which an area of a cross-section of each of the plurality of protrusions 300 decreases along a circumferential direction of the housing opening 12 from a center of each of the plurality of protrusions 300.

A predetermined interval between the plurality of protrusions 300 may be formed smaller than a length of the plurality of protrusions 300 in a circumferential direction of the second rim portion 222.

The first rim portion 221 may be configured to contact the diaphragm 100.

The first rim portion 221 may include the rim protrusion 224 protruding toward the diaphragm 100 above the plurality of protrusions 300 to contact the diaphragm 100.

The effects to be obtained from the present disclosure are not limited to those mentioned above, and other effects not mentioned will be apparent to those having ordinary skill in the art to which the present disclosure pertains from the following description.

Although specific embodiments have been illustrated and described above, the present invention is not limited to the above-described embodiments, and those of ordinary skill in the art to which the invention pertains will be able to make various modifications and changes without departing from the gist of the technical idea of the invention described in the claims below.

1. A clothes treating apparatus comprising:
a housing including a housing opening through which laundry is introduced;
a tub to be provided inside the housing;
a drum, which is rotatable, to be provided inside the tub;
a diaphragm to connect the housing and the tub; and
a door configured to open or close the housing opening,
wherein the door comprises:
a door glass;
a door frame configured to support the door glass; and
a door protrusion configured to protrude from the door frame toward a front surface of the housing,
wherein the door protrusion comprises a first protrusion portion to be positioned below the housing opening while the door is closed, and a second protrusion portion to extend downwardly from the first protrusion portion and be closer to the front surface of the housing than the first protrusion portion.

2. The clothes treating apparatus of claim 1, wherein
the door frame comprises:
a frame opening corresponding to the housing opening,
a first rim portion to be disposed around the frame opening to correspond to the diaphragm, and
a second rim portion, to be connected to the first rim portion, disposed on an outer side of the door frame relative to the first rim portion, and
the first protrusion portion protrudes from the first rim portion toward the diaphragm, and the second protrusion portion protrudes from the second rim portion toward the front surface of the housing.

3. The clothes treating apparatus of claim 1, wherein the second protrusion portion comprises a protruding surface extending along a vertical direction to be parallel to the front surface of the housing.

4. The clothes treating apparatus of claim 3, wherein the protruding surface is configured to contact the front surface of the housing.

5. The clothes treating apparatus of claim 3, wherein a gap between the second protrusion portion and the housing decreases from a lower end of the second protrusion portion to the protruding surface.

6. The clothes treating apparatus of claim 5, wherein the door protrusion comprises a portion having a cross-sectional area that decreases along a circumferential direction of the housing opening from a center of the door protrusion.

7. The clothes treating apparatus of claim 2, wherein the first protrusion portion is configured to contact the diaphragm.

8. The clothes treating apparatus of claim 2, wherein the door frame comprises a rim protrusion extending along an upper rim of the frame opening and protruding from the first rim portion toward the diaphragm to contact the diaphragm.

9. The clothes treating apparatus of claim 2, wherein a distance between the second rim portion and the front surface of the housing is shorter than a distance between the first rim portion and the front surface of the housing.

10. The clothes treating apparatus of claim 2, wherein
the door protrusion further comprises a third protrusion portion to protrude from the second protrusion portion toward the housing, and
the housing comprises a receiving portion concavely formed to receive the third protrusion portion.

11. The clothes treating apparatus of claim 10, wherein the third protrusion portion comprises a contact surface extending along a vertical direction to be parallel to a surface of the receiving portion.

12. The clothes treating apparatus of claim 10, wherein a portion of the third protrusion portion is configured to contact the receiving portion.

13. The clothes treating apparatus of claim 2, wherein the door protrusion comprises a plurality of protrusions disposed at predetermined intervals along a circumference of the frame opening.

14. The clothes treating apparatus of claim 13, wherein the predetermined intervals between the plurality of protrusions are smaller than a length of the plurality of protrusions along a circumferential direction of the frame opening.
